(19) United States
(12) Patent Application Publication
(10) Pub. No.: US 2004/0031924 A1
(43) Pub. Date: Feb. 19, 2004

(54) Infrared sensor assembly and refrigerator having the infrared sensor

(75) Inventors: Seong-Ho Cho, Seoul (KR); In-Seop Lee, Gyeonggi-Do (KR); In-Won Lee, Gyeonggi-Do (KR); Jae-Yong Sung, Seoul (KR); Jay-Ho Choi, Seoul (KR); Kwang-Hyup An, Seoul (KR); Jeong-Ho Lee, Gyeonggi-Do (KR); Young-Sok Nam, Seoul (KR)

Correspondence Address: GREENBLUM & BERNSTEIN, P.L.C., 1950 ROLAND CLARKE PLACE, RESTON, VA, 20191, US

(73) Assignee: LG ELECTONICS INC., Seoul (KR)

(21) Appl. No.: 10/316,861

(22) Filed: Dec. 12, 2002

(30) Foreign Application Priority Data
Aug. 17, 2002 (KR) 48733/2002

(51) Int. Cl. G01J 5/08

(52) U.S. Cl. 250/353

(57) ABSTRACT

Disclosed are an infrared sensor assembly for precisely detecting a location where a heat source is generated and a refrigerator having the infrared sensor. To this end, comprised are an infrared sensor fixed to a supporting frame for receiving infrared rays generated at the heat source; a case having the infrared sensor mounted therein and an infrared filter mounted at an upper surface thereof, the infrared filter transmits only the infrared rays; and a receiving range limiting means mounted between the infrared sensor and the infrared filter in the case for limiting a range of the infrared rays received into the infrared sensor so as to precisely detect a location of the heat source.

### BACKGROUND OF THE INVENTION

1. Field of the Invention

The present invention relates to an infrared sensor, and particularly, to an infrared sensor assembly for precisely detecting a location where a heat source is generated and a refrigerator having the infrared sensor.

2. Description of the Background Art

Generally, an infrared sensor detects physical quantity and chemical quantity such as a temperature, a pressure, and an intensity of radiation by using infrared rays having a wavelength which is longer than red light of visible rays and shorter than microwave among electromagentic waves, and converts the detected physical quantity and the chemical quantity into electricity quantity in which a signal process is possible, thereby outputting.

Especially, a thermopile infrared sensor is used as a non-contact far distance temperature measurement device which can measure a temperature of an object without directly contacting heat to the object.

FIG. 1 is a sectional view of the thermopile infrared sensor assembly in accordance with the conventional art.

The infrared sensor assembly according to the conventional art comprises: a supporting frame 102; an infrared sensor 104 fixed to the supporting frame 102 for detecting infrared rays radiated from an a heat source; and a case 108 fixed to the supporting frame 102 and having an infrared filter 106 mounted at an upper portion thereof, the case for receiving the infrared sensor 104.

The infrared sensor 104 includes: a infrared receiving portion 110 arranged at an upper portion thereof for detecting infrared rays radiated from the heat source; a fixing portion 112 for fixing the infrared receiving portion 110 to the supporting frame 102; and a terminal 116 connected with the infrared receiving portion 110 by a lead wire 114 for transmitting a signal value received from the infrared receiving portion 110 to a control unit (not shown).

In the conventional infrared sensor assembly, if a heat source is generated at a predetermined point, the infrared receiving portion 110 detects infrared rays radiated from the heat source and applies to the control unit. Then, the control unit determines a point where the heat source is generated and a temperature of the heat source. At this time, the infrared filter 106 transmits only the infrared rays, thereby measuring more precisely.

However, in the conventional infrared sensor assembly, since a receiving angle (θ1) taken to the infrared receiving portion is wide as approximately 60°, it is easy to detect whether the heat source is generated or not, but it is difficult to measure a precise point where the heat source is generated.

### SUMMARY OF THE INVENTION

Therefore, an object of the present invention is to provide an infrared sensor assembly which can precisely measure a location of the heat source by limiting a infrared receiving range of the infrared sensor.

Also, another object of the present invention is to provide a refrigerator to which the infrared sensor is applied, in which a point where a high temperature load inside the refrigerator is generated is precisely measured by limiting a infrared receiving range of the infrared sensor mounted in the refrigerator.

To achieve these and other advantages and in accordance with the purpose of the present invention, as embodied and broadly described herein, there is provided an infrared sensor assembly comprising: an infrared sensor fixed to a supporting frame for receiving infrared rays radiated at a heat source; a case having the infrared sensor mounted therein and an infrared filter mounted at an upper surface thereof; and a receiving range limiting means mounted between the infrared sensor and the infrared filter in the case for limiting a range of the infrared rays received into the infrared sensor so as to precisely detect a location of the heat source.

The receiving range limiting means is range limiting means is an infrared guide member mounted at an inner circumference surface of the case, the infrared guide member is provided with an infrared passage having a predetermined diameter which guides infrared rays which passed the infrared filter to the infrared sensor.

The infrared guide member is fabricated by molding resin with injection.

The infrared passage has a predetermined diameter so as to maintain a receiving angle of the infrared rays received to the infrared sensor as about 5°.

Inactive gas is contained in the infrared passage and in the case to which the infrared sensor is mounted.

An infrared lens installed at an upper portion of the infrared passage refracts infrared rays which passed the infrared filter so that the infrared rays can be received into the infrared sensor.

The infrared lens is made of chalcogenide glass.

The receiving range limiting means formed in the case as a one body includes an infrared guide member which guides infrared rays which passed the infrared filter to the infrared sensor so as to limit a receiving range of the infrared rays received to the infrared sensor.

The infrared guide member includes an infrared passage prolonged from an upper center of the case and formed as a cylindrical shape having a predetermined diameter; and a supporting portion prolonged from an end of the infrared passage to an outward direction and fixed to an inner circumference surface of the case.

A refrigerator having the infrared sensor according to the present invention comprises: a body divided into a freezing chamber and a chilling chamber by a partition wall; a blower attached to an upper portion of the freezing chamber for forcibly circulating cool air cooled by passing the freezing cycle; a cool air discharge duct for discharging the cool air blown by the blower into the chilling chamber; and an infrared sensor assembly mounted at an inner wall of the chilling chamber for detecting a temperature and a generation location of a high temperature load by receiving infrared rays generated at the high temperature load,

wherein, the infrared sensor assembly includes:

an infrared sensor fixed to a supporting frame for receiving infrared rays generated at a heat source; a case having the infrared sensor mounted therein and an infrared filter mounted at an upper surface thereof, the infrared filter transmits only the infrared rays; and a receiving range limiting means mounted between the infrared sensor and the infrared filter in the case for limiting a range of the infrared rays received into the infrared sensor so as to precisely detect a location of the heat source.

The receiving range limiting means is a cylindrical shape having a predetermined thickness and provided with an infrared guide member at the center thereof, in which the guide member guides infrared rays which passed the infrared filter to the infrared sensor and includes an infrared passage having a predetermined diameter.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a sectional view of an infrared sensor in accordance with the conventional art;

FIG. 2 is a sectional view of an infrared sensor assembly according to the first preferred embodiment of the present invention;

FIG. 3 is a sectional view of an infrared sensor assembly according to the second preferred embodiment of the present invention;

FIG. 4 is a sectional view of an infrared sensor assembly according to the third preferred embodiment of the present invention; and

FIG. 5 is a sectional view of a refrigerator to which the infrared sensor according to the present invention is applied.

### DETAILED DESCRIPTION OF THE PREFERRED EMBODIMENTS

Reference will now be made in detail to the preferred embodiments of the present invention, examples of which are illustrated in the accompanying drawings.

An infrared sensor assembly and a refrigerator to which the infrared sensor assembly is applied will be explained with reference to the preferred embodiments.

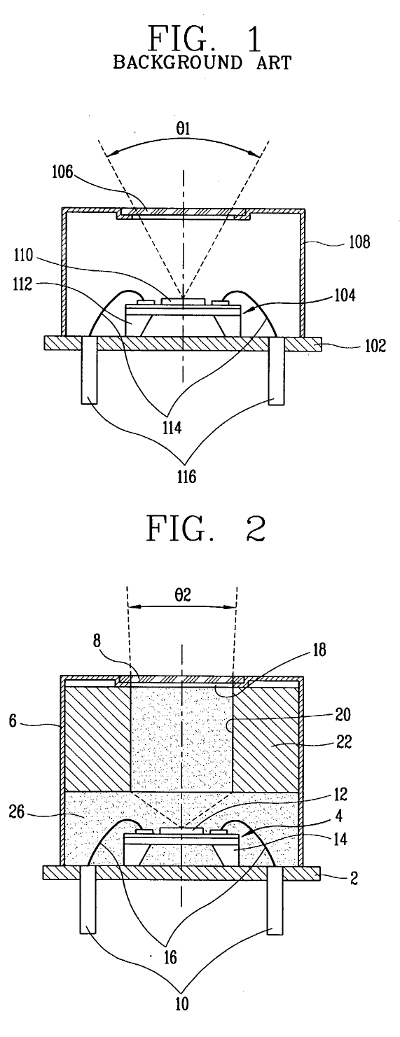

FIG. 2 is a sectional view of an infrared sensor assembly according to the first preferred embodiment of the present invention.

The infrared sensor assembly according to the present invention comprises: a supporting frame 2; an infrared sensor 4 fixed to an upper surface of the supporting frame 2 for receiving infrared rays radiated from a heat source located at a predetermined point; a case 6 fixed at an upper portion of the supporting frame 2 and having the infrared sensor 4 mounted therein and a predetermined space; an infrared filter 8 mounted at an open upper surface of the case 6 for transmitting only the infrared rays; and a receiving range limiting means installed in the case 6 for limiting a receiving range of the infrared rays received into the infrared sensor 4.

The supporting frame 2 is formed as a plate shape and fixed to a position separated from a point where the heat source is generated with a predetermined distance. At an upper portion of the supporting frame 2, the infrared sensor 4 is fixed. Also, a terminal 10 for applying an electric signal from the infrared sensor 4 to a control unit (not shown) is fixed to the supporting frame 2.

The infrared sensor 4 includes: a infrared receiving portion 12 for receiving infrared rays generated from the heat source; and a fixing portion 14 fixed to the supporting frame 2 for supporting the infrared receiving portion 12. Herein, the infrared receiving portion 12 is connected by the terminal 10 and a lead wire 16 to send a received signal to the control unit (not shown).

A bottom surface of the case 6 is fixed to an upper surface of the supporting frame 2, and a through hole 18 to which the infrared filter 8 is mounted is formed at an upper surface of the case 6. The case 6 has a predetermined space so as to maintain a predetermined distance between an upper surface of the infrared sensor 4 and the infrared filter 8.

The receiving range limiting means is fixed between the infrared sensor 4 and the infrared filter 8 in the case 6 and includes an infrared guide member 22 at the center thereof provided with an infrared passage 20 by which infrared rays passes.

That is, the infrared guide member 22 formed as a cylindrical shape having a predetermined thickness is provided with the infrared passage 20 at the center thereof, and an outer circumference surface of the infrared guide member is fixed to an inner circumference surface of the case 6. The infrared guide member 22 is preferably fabricated by injection-molding resin with a large quantity.

Herein, the infrared passage 20 guides infrared rays which passed the infrared filter 8 to the infrared receiving portion 12 of the infrared sensor 4. At this time, a receiving range of the infrared rays received into the infrared sensor 4 is limited by a diameter and a length of the infrared passage 20.

That is, when infrared rays generated from the heat source passes the infrared filter 8 and is guided to the infrared passage 20, the receiving angle is limited to a size corresponding to the diameter of the infrared passage 20, thereby the infrared rays are received to the infrared sensor 4. Accordingly, the shorter the diameter of the infrared passage 20 is, the less the receiving range of the infrared rays is, and vice versa. Also, the longer the length of the infrared passage 20 is, the less the receiving range of the infrared rays is, and vice versa.

Herein, it is preferable that the diameter of the infrared passage 20 is set to maintain the receiving angle of the infrared rays received to the infrared sensor 4 as about 5°.

Also, inactive gas 26 such as nitrogen which can prolong a life span is contained in the infrared passage 20 and in the case 6 to which the infrared sensor 4 is mounted.

Operations of the infrared sensor assembly according to the present invention will be explained as follows.

If the heat source is generated at one point, the infrared rays radiated from the heat source is received by the infrared sensor 4, thereby detecting a temperature of the heat source and a location where the heat source is generated.

That is, the infrared rays radiated from the heat source is filtered by the infrared filter 8 and guided to the infrared passage 20. At this time, since a receiving angle (η2) of the infrared rays is limited to a constant angle according to the diameter and the length of the infrared passage 20, the receiving range of the infrared rays received to the infrared sensor 4 is limited, thereby detecting a location where the heat source is generated precisely.

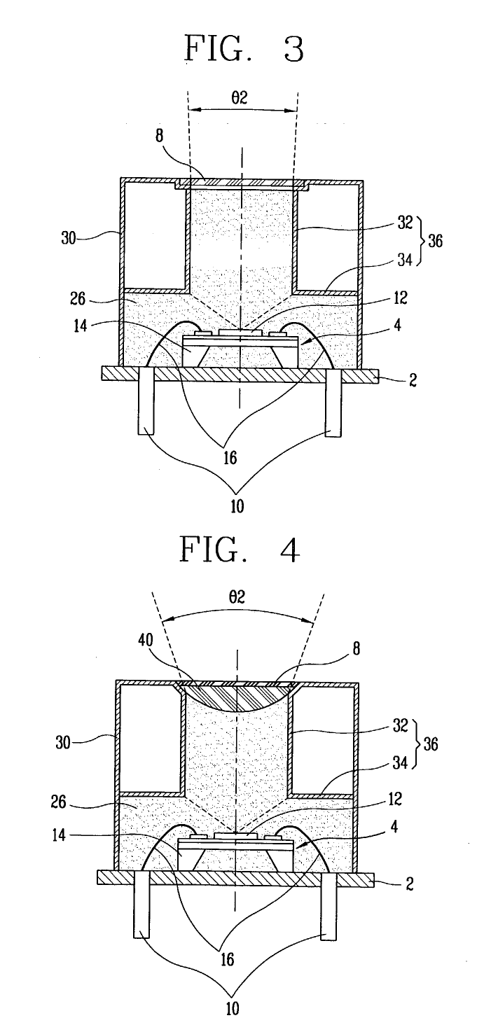

FIG. 3 is a sectional view of the infrared sensor assembly according to the second preferred embodiment of the present invention.

The infrared sensor assembly according to the second preferred embodiment comprises: an infrared sensor 4 fixed to an upper surface of a supporting frame 2 for receiving infrared rays radiated from a heat source located at a predetermined point; a case 30 fixed at an upper portion of the supporting frame 2 and having the infrared sensor 4 mounted therein and a predetermined space; an irifrared filter 8 mounted at an open upper surface of the case 30 for transmitting only the infrared rays; and a receiving range limiting means installed in the case 30 as a unit for limiting a receiving range of the infrared rays received into the infrared sensor 4.

Herein, the infrared sensor 4 is equal to that explained in the first preferred embodiment, so that its explanations will be omitted.

The case 30 is fixed to an upper surface of the supporting frame 2 and formed to have a predetermined length to an upper direction. In the case 30, an infrared guide member 36 corresponding to a receiving range limiting means is formed to guide infrared rays which passed the infrared filter 8 to the infrared sensor 4.

The infrared guide member 36 prolonged from an upper center of the case 30 to a downward direction as a unit includes an infrared passage 32 having a predetermined diameter by which the infrared rays passes; and a supporting portion 34 prolonged from an end of the infrared passage 32 to an outward direction and fixed to an inner circumference surface of the case 30.

Herein, the supporting portion 34 is formed at an upper surface of the infrared sensor 4 with a predetermined interval.

Also, inactive gas 26 such as nitrogen is contained in the infrared passage 32 and in the case to which the infrared sensor 4 is mounted.

The infrared sensor assembly according to the second embodiment contracts the receiving angle of the infrared rays received to the infrared sensor 4 by performing operations explained in the first embodiment.

FIG. 4 is a sectional view of the infrared sensor assembly according to the third preferred embodiment of the present invention.

The infrared sensor assembly according to the third preferred embodiment has the same construction with that explained in the second preferred embodiment. However, one different thing is that an infrared lens 40 for refracting the infrared rays so that infrared rays which passed the infrared filter 8 can be received into the infrared receiving portion 12 of the infrared sensor 4 is installed at an inner circumference surface of the infrared passage 32.

The infrared lens 40 is preferably made of chalcogenide glass having an excellent infrared transmittance and inject-molded with a large quantity.

The infrared lens 40 is installed at the inner circumference surface of the infrared passage of the infrared guide member and performs the same operations explained in the third preferred embodiment.

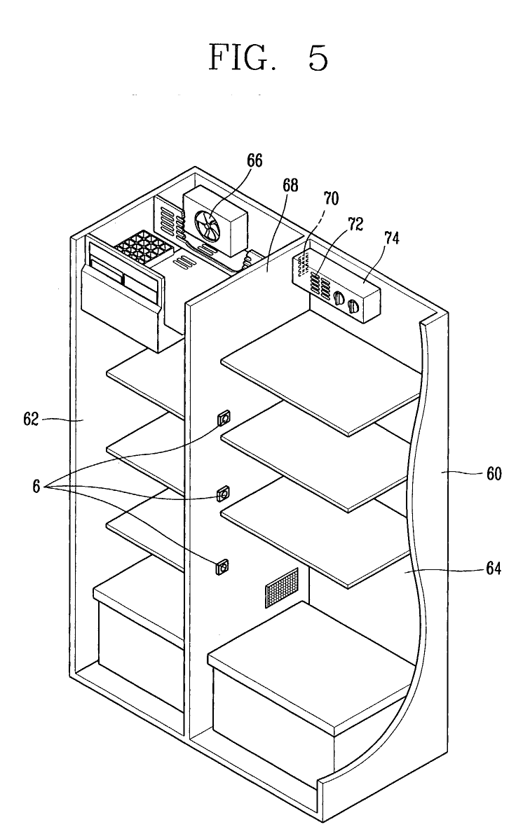

FIG. 5 is a sectional view of a refrigerator to which the infrared sensor according to the present invention is provided.

A refrigerator having the infrared sensor comprises: a body 60 having a predetermined space to store food; a blower 66 attached to an upper portion of the freezing chamber 62 arranged on the right of the body 60 for forcibly circulating cool air cooled by passing the freezing cycle; a cool air supply passage 70 formed at an upper side of a partition wall 8 which divides the freezing chamber 62 and a chilling chamber 64 for supplying cool air blown from the fan 66 into the chilling chamber 64, a cool air discharge duct 74 connected to the cool air supply passage 70, installed at an upper side of the chilling chamber 64, and provided with a cool air discharge opening 72 for discharging cool air to the chilling chamber 64; infrared sensors 4 mounted at an inner wall of the chilling chamber 64 for detecting a temperature and a generation location of a high temperature load by receiving infrared rays generated at the high temperature load; a case 6 having the infrared sensors 4 mounted therein and an infrared filter 8 mounted at an upper surface thereof, the infrared filter filters transmits only the infrared rays; and a receiving range limiting means mounted between the infrared sensor 4 and the infrared filter in the case for limiting a range of the infrared rays received into the infrared sensor 4 so as to precisely detect a location of the heat source.

Since the infrared sensor 4 has the same constructions with that explained in the first embodiment, its explanations will be omitted.

Since the receiving range limiting means has the same constructions with that explained in the first, second, and third embodiments, its explanations will be omitted.

The infrared sensor assembly and the refrigerator having the infrared sensor assembly according to the present invention have the following advantages.

First, a receiving range of the infrared rays received to the infrared sensor from the heat source is limited by installing the infrared guide member which guides infrared rays which passed the infrared filter to the infrared sensor at the upper inner circumference surface of the case to which the infrared sensor is mounted, thereby precisely detecting a location where the heat source is generated.

Also, by installing the receiving range limiting means to the infrared sensor mounted in the refrigerator, a location where the high temperature load inside the refrigerator is generated can be precisely detected, thereby having a fast cooling performance.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. An infrared sensor assembly comprising:
an infrared sensor fixed to a supporting frame for receiving infrared rays radiated at a heat source;
a case having the infrared sensor mounted therein and an infrared filter mounted at an upper surface thereof; and
a receiving range limiting means mounted between the infrared sensor and the infrared filter in the case for limiting a range of the infrared rays received into the infrared sensor so as to precisely detect a location of the heat source.

2. The infrared sensor assembly of claim 1, wherein the receiving range limiting means is an infrared guide member mounted at an inner circumference surface of the case, the infrared guide member is provided with an infrared passage having a predetermined diameter which guides infrared rays which passed the infrared filter to the infrared sensor.

3. The infrared sensor assembly of claim 2, wherein the infrared guide member is fabricated by molding resin with injection.

4. The infrared sensor assembly of claim 2, wherein, the infrared passage has a predetermined diameter in order to maintain a receiving angle of the infrared rays received to the infrared sensor as about 50.

5. The infrared sensor assembly of claim 2, wherein inactive gas is contained in the infrared passage and in the case to which the infrared sensor is mounted.

6. The infrared sensor assembly of claim 2, wherein an infrared lens installed at an upper portion of the infrared passage refracts infrared rays which passed the infrared filter so that the infrared rays can be received to the infrared sensor.

7. The infrared sensor assembly of claim 6, wherein the infrared lens is made of chalcogenide glass.

8. The infrared sensor assembly of claim 1, wherein the receiving range limiting means formed in the case as a one body includes an infrared guide member which guides infrared rays which passed the infrared filter to the infrared sensor so as to limit a receiving range of the infrared rays received to the infrared sensor.

9. The infrared sensor assembly of claim 8, wherein the infrared guide member includes an infrared passage prolonged from an upper center of the case and formed as a cylindrical shape having a predetermined diameter; and a supporting portion prolonged from an end of the infrared passage to an outward direction and fixed to an inner circumference surface of the case.

10. The infrared sensor assembly of claim 9, wherein inactive gas is contained in the infrared passage and in the case to which the infrared sensor is mounted.

11. The infrared sensor assembly of claim 9, wherein an infrared lens is installed at an inner circumference surface of the infrared passage for refracting infrared rays which passed the infrared filter so that the infrared rays can be received to the infrared sensor.

12. The infrared sensor assembly of claim 11, wherein the infrared lens is made of chalcogenide glass.

13. A refrigerator having an infrared sensor, the refrigerator comprising:
a body divided into a freezing chamber and a chilling chamber by a partition wall and having a predetermined space to store food;
a blower attached to an upper portion of the freezing chamber for forcibly circulating cool air cooled by passing the freezing cycle;
a cool air discharge duct for discharging the cool air blown by the blower into the chilling chamber; and
an infrared sensor assembly mounted at an inner wall of the chilling chamber for detecting a temperature and a generation location of high temperature load by receiving infrared rays generated at the high temperature load,
wherein, the infrared sensor assembly includes:
an infrared sensor fixed to a supporting frame for receiving infrared rays generated at a heat source;
a case having the infrared sensor mounted therein and an infrared filter mounted at an upper surface thereof, the infrared filter transmits only the infrared rays; and
a receiving range limiting means mounted between the infrared sensor and the infrared filter in the case for limiting a range of the infrared rays received into the infrared sensor so as to precisely detect a location of the heat source.

14. The infrared sensor assembly 13, wherein the receiving range limiting means is a cylindrical shape having a predetermined thickness and provided with an infrared guide member at the center thereof, the guide member which guides infrared rays which passed the infrared filter to the infrared sensor and includes an infrared passage having a predetermined diameter.

15. The infrared sensor assembly of claim 14, wherein the infrared guide member is fabricated by molding resin with injection.

16. The infrared sensor assembly of claim 14, wherein the infrared guide member is formed as a unit with the case at an inner circumference surface thereof.

17. The infrared sensor assembly of claim 14, wherein inactive gas is contained in the infrared passage and in the case to which the infrared sensor is mounted.

18. The infrared sensor assembly of claim 14, wherein an infrared lens installed at an upper portion of the infrared passage refracts infrared rays which passed the infrared filter so that the infrared rays can be received into the infrared sensor.

19. The infrared sensor assembly of claim 18, wherein the infrared lens is made of chalcogenide glass.
